(19) United States
(12) Patent Application Publication
(10) Pub. No.: US 2026/0053129 A1
(43) Pub. Date: Feb. 26, 2026

(54) SPRAY NOZZLE FOR NEBULIZER

(71) Applicant: GUARANY INDÚSTRIA E COMÉRCIO LTDA., Itú (BR)

(72) Inventor: ALIDA MARIA FLEURY, São Paulo (BR)

(21) Appl. No.: 19/242,998

(22) Filed: Jun. 19, 2025

(30) Foreign Application Priority Data
Aug. 20, 2024 (BR) 1020240169794

(51) Int. Cl. A01M 1/20; B05B 1/34

(52) U.S. Cl. CPC A01M 1/2022; B05B 1/3402

(57) ABSTRACT

The insecticide nebulizer nozzle of the invention comprises a hollow base (1) and body (2), interconnected with each other, with ends (11 and 21) open for liquid/gas inlet/outlet. Said body internally surrounds a restrictor (5), an internal base (6) and a smooth tube (7), which together make it possible to spray a mixture of gas and liquid into small particles in a laminar regime. On the side of the body (1), there is a spigot (8) that allows the insertion of liquid near the inner base (6) of the nozzle. Through the inner base (6) the liquid is directed towards the end (21) of the outlet. After passing through the restrictor (5) and the internal base (6) the liquid meets the air at high speed and rotating, favoring its complete breakdown into droplets. The droplets are displaced by the smooth tube in laminar flow.

### TECHNICAL SECTOR

The present invention belongs to the technological sector of equipment for environmental health control. More specifically, it refers to a nozzle for aerosol insecticide nebulizer, containing a smooth tube, an internal base and a restrictor that together allow the spraying of insecticide in laminar regime and in small particles.

### STATE OF THE ART

The insecticide nebulizer is an effective piece of equipment in controlling urban pests and protecting against insect-borne diseases. Used in both residential and commercial environments, these devices disperse small particles of insecticide into the air, reaching hard-to-reach areas and eliminating pests and invaders. The equipment makes it possible to reach places where insects hide, such as cracks, crevices and densely furnished areas. In addition to their effectiveness in eradicating pests, nebulizers contribute to the protection and maintenance of environments free of unwanted insects.

In order for the aerosol to be sprayed correctly, the nebulizers have nozzles, which help in the proper distribution of the insecticide in aerosol. This component is designed to transform the insecticidal liquid into small particles, which are then dispersed into the air evenly and effectively. There are different types of nebulizer nozzles, each designed to meet specific application needs. Some nozzles are adjustable, allowing you to control the size of the droplets produced. This is important, as the size of the particles directly influences the coverage of the area and the effectiveness of the treatment. Droplets that are too large may not reach critical areas, while droplets that are too small may not have the necessary weight to reach the desired target before evaporating.

The patent document U.S. Pat. No. 5,553,784 describes a nozzle for nebulizers or similar equipment that performs the spraying of gas mixed with liquid, containing multiple discharge outlets arranged in a single mixing zone, where the discharge outlets are arranged concentrically, alternating between water and gas streams. A limitation of this type of nozzle is to contain only one base with an orifice, without a restrictor, limiting the control of the dispersion and size of the droplets. Thus, it is not possible to precisely control the direction of the matter and the equipment needs to have high power so that it can disperse small droplets.

The patent document CN103769324 describes a water and gas spray nozzle with internal mixing and atomization. The nozzle comprises a spray nozzle body and a spray nozzle cap, wherein the spray nozzle body is provided with a liquid passage and a gas passage, the spray nozzle cap head part is provided with a plurality of spray holes, the spray nozzle cap is provided with a mixing region and a spray cavity, the liquid passage and the gas passage are respectively communicated with the mixing region. One limitation of this technology is to present straight holes in the nozzle and dispersion in a turbulent regime, making it difficult for particles to break and reducing their speed.

### NOVELTIES AND OBJECTIVE OF THE INVENTION

The objective of the present invention is a nozzle for a nebulizer that effectively solves the limitations of the previously mentioned state of the art.

The nozzle for insecticide nebulizer comprises an empty body with liquid outlet at its top. Said body internally surrounds a smooth tube, an internal base and a restrictor/director, which together make it possible to spray a mixture of gas and liquid into small particles in a laminar regime. On the side of the body, there is a spigot that allows the insertion of liquid near the inner base of the nozzle. The liquid enters the inner base through a spigot. Through the inner base the liquid is directed towards the upper outlet. In the outlet region the liquid meets the air at high speed and rotating, favoring its complete breakdown into droplets. The droplets, in turn, are displaced by the smooth tube in laminar flow.

### ADVANTAGES AND TECHNICAL EFFECTS OF THE INVENTION

The nozzle for nebulizers, object of the present invention, results in the following advantages and achieves the following technical effects over the nozzles of the state of the art:
The nozzles for nebulizers of the state of the art have elements that interfere with the flow of the mixture for spraying the insecticides by the nebulizers, generating pressure loss and transforming the flow into a turbulent regime, reducing its speed and reach. This problem was solved by the present invention through the application of a smooth tube applied after the internal base of the nebulizer, in this way, there are no interference elements of the insecticide flow, keeping it in laminar regime; and
State-of-the-art nebulizer nozzles require internal bases with holes that cause great interference in the flow of the insecticide to generate the breakdown into small particles, reducing the speed and reach of the sprayed mixture. Thus, it is necessary that the nebulizers have high power to properly expel insecticides in small particles, in order to supply the pressure loss generated by the nozzle. Solved by this invention through a restrictor assembly, internal base with angled holes and smooth tube, which guarantee the breakdown of particles, reducing their diameter, without causing great pressure loss, allowing the pulverization of particles with a diameter close to 20 microns in laminar regime by low-power nebulizers, that is, nebulizers that use blowers with an air volume of less than 350 CFM.

### LIST OF ACCOMPANYING DRAWINGS

In order for this invention to be fully understood and put into practice by any person skilled in the art, it is now described in a clear, precise and sufficient manner, based on the accompanying drawings, listed below, which illustrate the preferred embodiments of the nozzle for nebulizers:

FIG. 1—perspective view of the front part of the nozzle for nebulizers;

FIG. 2—perspective view of the rear part of the nozzle for nebulizers;

FIG. 3—cutaway view of the nozzle for nebulizers;

FIG. 4—exploded perspective view of the nozzle for nebulizers;

FIG. 5—perspective view of the nebulizer nozzle restrictor;

FIG. 6—perspective view of the internal base of the nebulizer nozzle; and

FIG. 7—perspective view of the smooth tube of the nebulizer nozzle.

### DETAILED DESCRIPTION OF THE INVENTION

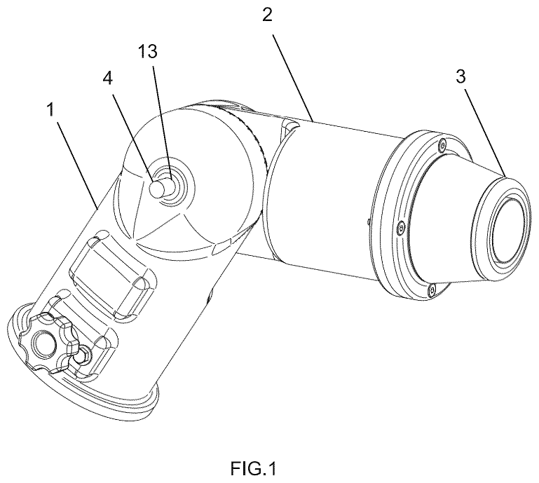

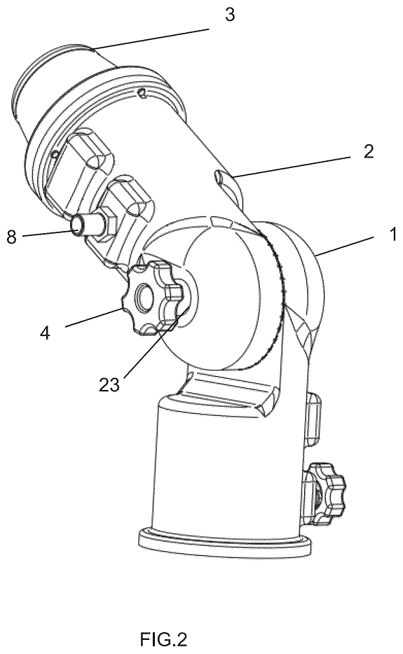

FIGS. 1 and 2 illustrate the nozzle for nebulizers, which comprises a base (1) connected to a body (2) connected to a ferrule (3) at its end. The base (1) and the body (2) have the same layout, containing a cylindrical shape, empty interior, one end (11 and 21) open for liquid/gas entry/exit, a recess in its central part forming a semi-cylinder with a closed end and a side opening (12 and 22) for liquid/gas entry/exit. The base (1) and body (2) are interconnected through a handle (4), which is fixed to the holes (13 and 23), along with this, the lateral openings (12 and 22) have reliefs and recesses in their profile, which act as male-female fittings for coupling between the base (1) and the body (2). The ferrule (3) is attached to the body (2) by means of fastening elements, such as screws or similar. Said ferrule (3) presents an empty, truncated cone shaped body with open ends.

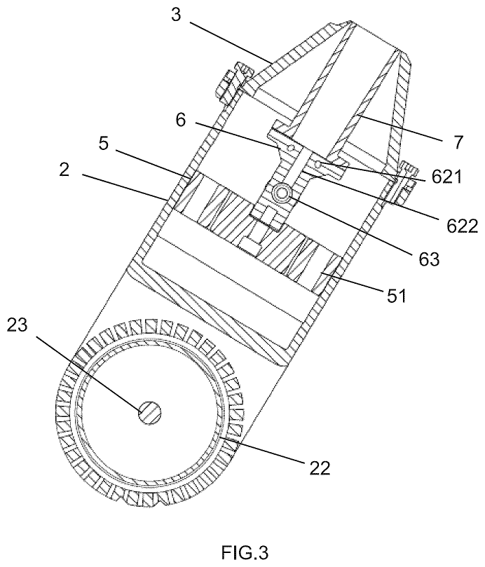

FIG. 3 illustrates the internal components that make up the nozzle for nebulizers, surrounded by the body (2) and ferrule (3). The internal nozzle assembly consists of a restrictor/director (5), an internal base (6) and a smooth tube (7). These elements control the pressure, direction and breakdown of the particles, reducing the diameter of the insecticide particles for spraying.

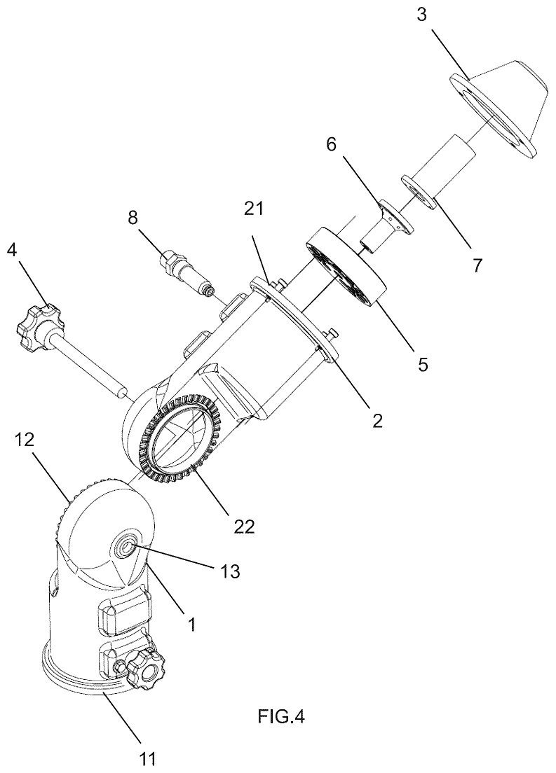

FIG. 4 details the displacement of the mixture (liquid+gas) inside the nozzle. The source gas of the nebulizer enters inside the base (1) and is directed towards the body (2). Inside the body (2) the gas passes through the orifices (51) of the restrictor (5), restricting the passage of the gas and increasing its pressure. Then, the gas enters the internal base (6) which, simultaneously, receives the injection of liquid insecticide, through a spigot (8). The gas then passes through the angled orifices (621) and the liquid passes through the central orifice (622) of the base (6), and are mixed at the exit end of the base (6) and directed through the smooth tube (7), mixing and breaking the particles, forming particles with a diameter close to 20 microns. The mixture runs through the smooth tube (7) which keeps the mixture in a laminar regime until it is expelled through the ferrule (3).

The use of the combination of elements, restrictor (5), internal base (6) and smooth tube (7), allows the nebulizer not to need a high power to efficiently expel the insecticide in particles smaller than 20 microns. This fact occurs because the restrictor generates an increase in internal pressure in the nozzle, replacing the effect that was previously generated by a high-power blower-motor assembly.

FIG. 5 illustrates the restrictor/director (5) of the nozzle for nebulizers, consisting of a disc-shaped body with holes (51) to restrict and direct the passage of gas inside the nozzle, thus controlling the pressure of the moving gas. The restrictor (5) is secured by fastening elements such as four screws in the body (2) or one screw in the base (6). The orifices (51) have a varied quantity, but preferably above 15 and diameters preferably between 10 and 20 mm. In addition to generating the necessary pressure to break the droplet, the holes (51) were defined to make the engine work at optimal speed, because through the pressure generated in the nozzle the load on the engine is controlled.

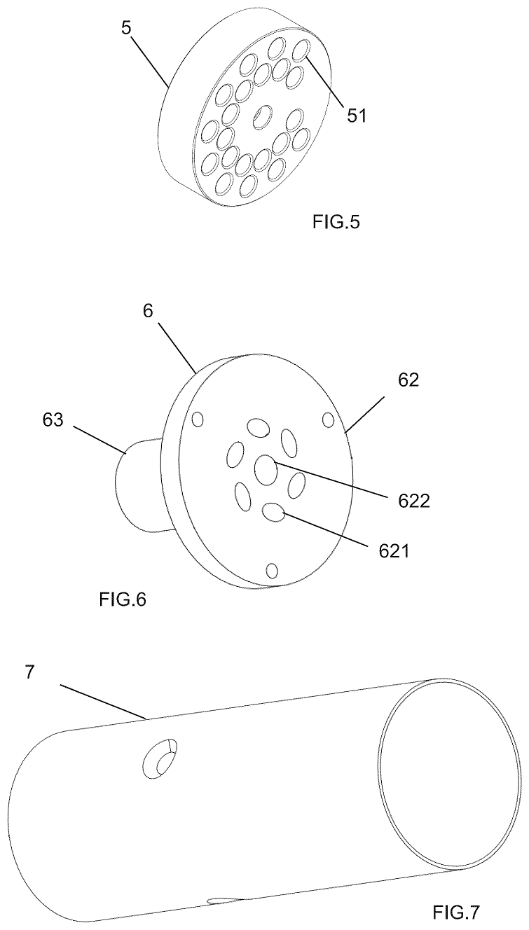

FIG. 6 illustrates the inner base (6) composed of a chamber (63) interconnected to a disk (62). The chamber (63) receives the insecticide injection from the spigot (8) and directs it towards the central orifice (622) of the disc (62). Said disc (62) has angled holes (621) and central hole (622), said angled holes (621) have an angle between 40° and 60° in the transverse direction and between 30° and 50° in the longitudinal direction and receive the gas from the nebulizer, directing it towards the smooth tube (7) where they meet the insecticide particles, expelled through the central hole (622), breaking them into particles with a diameter close to 20 microns. More precisely, the angles of the holes (621) are 50° in the transverse direction and 40° in the longitudinal direction. The angulation of the holes (621) causes the air to move in rotation, making it easier for the particles to break down.

FIG. 7 illustrates the smooth tube (7) formed by a hollow cylindrical body with both ends open and the interior in a concave shape. The sprayed mixture enters the tube (7) at one end with a smaller diameter and exits at an end with a larger diameter. In order not to create interference or loss of pressure and to keep the mixture in laminar regime. At the end of the smooth tube (7) the mixture meets the secondary air, coming from the outer region to the base (6), this air flow has the function of generating a new drop break and carrying the spray to obtain the spray range.

The spigot (8) is attached to a hole in the side of the body (2) by fastening elements, such as a nut, and connects directly to the chamber (63), directing the insecticide from the nebulizer into the nozzle.

The inner base (6) and the smooth tube (7) are fixed to each other by means of fasteners. And the smooth tube (7) is not fixed to the ferrule (3), so that the secondary air passage occurs, that is, air that does not pass through the interior of the base (6).

Thus, the nozzle of this invention controls the spray pattern, the size of the droplets, and the distribution of the liquid, ensuring an efficient and precise application. Performing the control of the insecticide's drift, allowing it to reach all desired targets. In addition, it regulates the pressure and flow of the liquid, allowing the nebulizer to operate efficiently, even if it has a low power profile (blowers with an air volume of less than 350 CFM).

The nozzle is connected to the nebulizer equipment by attaching the base (1) to the nebulizer discharge pipe by means of fastening elements, such as a handle, for example, but not limited to it. In addition, the nozzle can also be used in sprayer equipment or similar.

1. A NEBULIZER NOZZLE which comprises a base (1) with hollow interior, open end (11) and side opening (12) connected to the opening (22) of a body (2); wherein said body (2) has a hollow interior, open end (21) and side opening (22), and, the body (2) surrounds an internal base (6) and is attached to a ferrule (3), characterized in that the nozzle is constituted of:
the openings (12 and 22) that connect the base (1) and the body (2) have reliefs and recesses on the contact face in their profile, which act as male-female sockets; said body (2) receives a spigot (8) fixed next to a orifice, connecting directly to the chamber (63);
ferrule (3) composed of an empty body with open ends and fixed to the end (21) of the body (2) by means of fastening elements; and the ferrule (3) presents an empty, truncated cone shaped body with open ends;
said body (2) and ferrule (3) involve a restrictor (5) with orifices (51), an internal base (6) with orifices and a smooth tube (7) with an empty interior, connected to each other, forming a flow for spraying;
said internal base (6) is composed of a chamber (63) interconnected to a disk (62); the chamber (63) receives the injection of insecticide from the spigot (8) and directs it towards the central orifice (622) of the disk (62); said disk (62) presents angled orifices (621) and central orifice (622).

2. THE NEBULIZER NOZZLE according to claim 1, characterized in that the base (1) and the body (2) have the same arrangement, containing a cylindrical shape, empty interior, a recess in its central part forming a semi-cylinder with a closed end; the base (1) and body (2) are interconnected by a handle (4), which is attached to the orifices (13 and 23).

3. THE NEBULIZER NOZZLE according to claim 1, characterized in that the angled orifices (621) present an angle between 40° and 60° in the transversal direction and between 30° and 50° in the longitudinal direction and receive the gas from the nebulizer, directing it towards the smooth tube (7).

4. THE NEBULIZER NOZZLE according to claim 1, characterized in that the smooth tube (7) formed by an empty cylindrical body with both ends open and the inside concave in shape, containing an inlet end with a smaller diameter and an outlet end with a larger diameter.
